(19) United States
(12) Patent Application Publication
(10) Pub. No.: US 2026/0230460 A1
(43) Pub. Date: Aug. 6, 2026

(54) Enrolling MUD Devices

(71) Applicant: Telefonaktiebolaget LM Ericsson (publ), Stockholm (SE)

(72) Inventors: Jaime Jiménez, Espoo (FI); Patrik Salmela, Espoo (FI); Jari Arkko, Kauniainen (FI)

(21) Appl. No.: 19/142,686

(22) PCT Filed: Dec. 27, 2022
(86) PCT No.: PCT/SE2022/051246

§ 371 Date: Jun. 24, 2025

(51) Int. Cl. H04L 9/40

(52) U.S. Cl. CPC H04L 63/08

(57) ABSTRACT

The present disclosure relates to a method of a Manufacturer Usage Description (MUD) file server (13) enrolling a MUD device (12 ) and a MUD file server (13) performing the method, and a method of a MUD manager (12) verifying a MUD device (10) and a MUD manager MUD MUD (12) performing the method. The present disclosure further relates to computer programs (112, 212) and computer program products. In an aspect, a method of a MUD file server (13) enrolling a MUD device (10) is provided. The method comprises receiving (S101) authentication data from the MUD device (10), verifying (S102) the received authentication data, associating (S103) an identifier of the MUD device (10) with a MUD file assigned to the MUD device (10) and providing (S104) the MUD device (10) with a data destination to the assigned MUD file.

### TECHNICAL FIELD

The present disclosure relates to a method of a Manufacturer Usage Description (MUD) file server enrolling a MUD device and a MUD file server performing the method, and a method of a MUD manager verifying a MUD device and a MUD manager performing the method. The present disclosure further relates to computer programs and computer program products.

### BACKGROUND

Manufacturer Usage Description (MUD) specification set out for instance in request for comment no. 8520 (RFC 8520) discusses a MUD file that describes various aspects of a device. The MUD file is typically created by a manufacturer of the device and includes information related to communication patterns and policies of the device (e.g. what services the device is expected to and/or allowed to connect to).

MUD is designed for, but not technically limited to, Internet-of-Things (IoT) devices with relatively clear and simple communication patterns that easily can be described in a MUD file. A personal computer would typically have a very complex communication pattern that is unpredictable and that would be difficult to describe.

A problem with MUD files is that the level of security is fairly low; there is no way to know whether or not a MUD file being advertised by a device indeed belongs to that particular device or if the device is (possibly) maliciously advertising a MUD file belonging to some other device. There is thus room for improvement as regards security.

### SUMMARY

One objective is to solve, or at least mitigate, this problem and thus to provide a method for improving security when using MUD files.

This objective is attained in a first aspect by a method of a MUD file server enrolling a MUD device. The method comprises receiving authentication data from the MUD device, verifying the received authentication data, associating an identifier of the MUD device with a MUD file assigned to the MUD device and providing the MUD device with a destination to the assigned MUD file.

This objective is attained in a second aspect by a MUD file server configured to enroll a MUD device, comprising a processing unit and a memory, said memory containing instructions executable by said processing unit, whereby the MUD file server is operative to receive authentication data from the MUD device, verify the received authentication data, associate an identifier of the MUD device with a MUD file assigned to the MUD device and provide the MUD device with a destination to the assigned MUD file.

This objective is attained in a third aspect by a method of a MUD manager verifying a MUD device. The method comprises acquiring an authenticated identifier of the MUD device and verifying that the authenticated acquired identifier is associated with a MUD file assigned to the MUD device, wherein a communication policy specified in the MUD file can be applied for the MUD device.

This objective is attained in a fourth aspect by a MUD manager configured to verify a MUD device, the MUD manager comprising a processing unit and a memory, said memory containing instructions executable by said processing unit, whereby the MUD manager is operative to acquire an authenticated identifier of the MUD device and verify that the authenticated acquired identifier is associated with a MUD file assigned to the MUD device, wherein a communication policy specified in the MUD file can be applied for the MUD device.

Advantageously, an authenticated MUD device identifier is associated with a MUD file to allow a MUD manager to subsequently verify that a MUD device presenting a destination of, such as a pointer to, the MUD file indeed is an enrolled MUD device, and not a malicious device performing e.g. an attack using the pointer.

In an embodiment, the verifying of the received authentication data comprises the MUD device proving knowledge of a secret shared with the MUD file server or a trusted third party.

In an embodiment, the associating of an identifier of the MUD device with a MUD file assigned to the MUD device comprises including the identifier of the MUD device in the MUD file.

In an embodiment, the identifier of the MUD device is included in a MUD file specifically assigned to the MUD device.

In an embodiment, the identifier of the MUD device is added to a common MUD file shared with a plurality of MUD devices.

In an embodiment, the associating of an identifier of the MUD device with a MUD file assigned to the MUD device comprises including the identifier of the MUD device with the destination.

In an embodiment, the associating of an identifier of the MUD device with a MUD file assigned to the MUD device comprises including the identifier of the MUD device in the MUD file and with the destination.

In an embodiment, the provided destination being a uniform resource locator (URL).

In an embodiment, the identifier of the MUD device is acquired via payload data received with the authentication data or via communication header data received with the authentication data.

In an embodiment, the method further comprises selecting a MUD file to be assigned to the MUD device based on a device-type identifier of the MUD device.

In an embodiment, the method further comprises selecting a MUD file to be assigned to the MUD device based on a user instruction of an owner of the MUD device.

In an embodiment, the method further comprises receiving a request from a MUD manager to provide the MUD file of the MUD device in response to which the MUD file is distributed to the MUD manager.

In an embodiment, the method further comprises distributing the MUD file and/or the destination to a MUD manager.

In an embodiment, the method further comprises providing the MUD file with a digital signature to be verified with a public key corresponding to a private key utilized to provide the digital signature.

In an embodiment, the verifying of the received authentication data comprises verifying received authentication data for a plurality of identifiers for the MUD device and the associating an identifier of the MUD device with a MUD file assigned to the MUD device comprises associating the plurality of identifiers with the MUD file.

In an embodiment, the providing of the MUD device with a destination to the assigned MUD file comprises providing a separate destination indicator for each identifier, all destination indicators indicating the same MUD file.

In an embodiment, the MUD manager receives the MUD file from a MUD file server.

In an embodiment, the MUD manager requests and receives the MUD file from a MUD file server utilizing a MUD file destination received from an access device via which the MUD device requests access.

In an embodiment, the verifying that the acquired authenticated identifier is associated with a MUD file assigned to the MUD device comprises verifying that the acquired authenticated identifier corresponds to an identifier in the MUD file.

In an embodiment, the verifying that the acquired authenticated identifier is associated with a MUD file assigned to the MUD device comprises verifying that the acquired authenticated identifier corresponds to an identifier included with said destination.

In an embodiment, the verifying that the acquired authenticated identifier is associated with a MUD file assigned to the MUD device comprises verifying that the acquired authenticated identifier corresponds to an identifier in the MUD file and to an identifier included with said destination.

In an embodiment, the verifying that the acquired authenticated identifier is associated with a MUD file assigned to the MUD device comprises determining that the MUD file is a device specific MUD file and that for subsequent verifications only device specific MUD files will be successfully verified for said MUD device.

In a fifth aspect, a computer program is provided comprising computer-executable instructions for causing a MUD file server to perform steps recited in the method of the first aspect when the computer-executable instructions are executed on a processing unit included in the MUD file server.

In a sixth aspect, a computer program product is provided comprising a computer readable medium, the computer readable medium having the computer program according to the fifth aspect embodied thereon.

In a seventh aspect, a computer program is provided comprising computer-executable instructions for causing a MUD manager (to perform steps recited in the method of the third aspect when the computer-executable instructions are executed on a processing unit included in the MUD manager.

In an eighth aspect, a computer program product is provided comprising a computer readable medium, the computer readable medium having the computer program according to the seventh aspect embodied thereon.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated.

### BRIEF DESCRIPTION OF THE DRAWINGS

Aspects and embodiments are now described, by way of example, with reference to the accompanying drawings, in which:

FIG. 1 shows a signaling diagram illustrating signaling in a prior art MUD architecture;

FIG. 2 shows a signaling diagram illustrating a method of enrolling a MUD device at a MUD file server according to this embodiment;

FIG. 3 shows a signaling diagram illustrating the MUD device connecting to an access network according to an embodiment;

FIG. 4 shows a signaling diagram illustrating a further embodiment, where the MUD file server hosts MUD files for many different MUD device types;

FIG. 5 shows a signaling diagram illustrating another embodiment, where a user is allowed to select a MUD file to be assigned;

FIG. 6 shows a signaling diagram illustrating another embodiment, where the MUD file is distributed to the MUD manager after the MUD device has been enrolled;

FIG. 7 illustrates a MUD file server according to an embodiment; and

FIG. 8 illustrates a MUD manager according to an embodiment.

### DETAILED DESCRIPTION

The aspects of the present disclosure will now be described more fully hereinafter with reference to the accompanying drawings, in which certain embodiments of the invention are shown.

These aspects may, however, be embodied in many different forms and should not be construed as limiting; rather, these embodiments are provided by way of example so that this disclosure will be thorough and complete, and to fully convey the scope of all aspects of invention to those skilled in the art. Like numbers refer to like elements throughout the description.

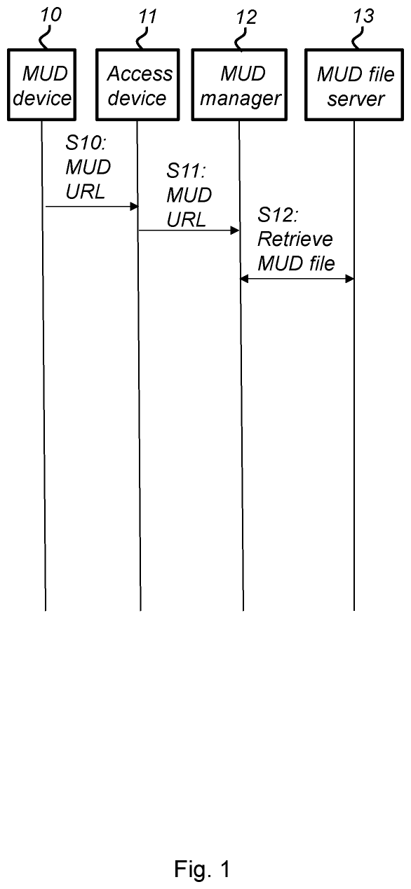

FIG. 1 shows a signaling diagram illustrating signaling in a prior art MUD architecture as set out in previously mentioned RFC 8520.

When a MUD device 10 (commonly referred to as a thing) connects S10 to an access network via an access device 11 such as e.g. a router or a switch, the MUD device 10 will communicate a pointer, in this example in the form of a uniform resource locator (URL), to its MUD file stored by a MUD file server 13 hosted by a manufacturer of the MUD device 10.

The access device 11 intercepts this MUD URL and forwards S11 it to a MUD manager 12 in the access network. The MUD manager 12 uses the URL to connect to the MUD file server 13 (to which the URL points) and retrieve S12 the MUD file pointed to by the URL. The MUD manager 12 then interprets the MUD file and applies network access policies based on the content of the MUD file for the attached MUD device 10.

Thus, the MUD file is intended to be used by a provider of the access network to limit and tailor the communication of the MUD device 10 to pre-defined communication policy specified in the MUD file and thereby improve security and access network performance of the MUD device 10. The MUD file could also be used for configuring the access network to fit the requirements of the MUD device 10, e.g., related to reachability through network address translations (NATs).

The MUD URL may be communicated by the MUD device 10 to the MUD manager 12 via the access device 11 in multiple ways, such as in a dynamic host configuration protocol (DHCP) request or in an extensible authentication protocol (EAP) message used for access authentication.

The MUD files hosted by the MUD server 13 are typically device-type specific MUD files (e.g., all smart lightbulbs of a certain model of a manufacturer would all advertise the same MUD URL).

Further, there is no way of knowing if the MUD URL advertised by a MUD device 10 actually is the MUD file of that particular device; a malicious device—such as e.g. a hacked device or device being part of a botnet—may select to advertise a MUD URL of another device, which may have less restrictions with respect to communication patterns and use of network resources.

Moreover, the MUD server 13 may optionally modify a MUD file, which would not be explicitly flagged to the local access network of the MUD device 10, i.e. the access network would not be aware of the modifications. The changes to the MUD file would be applied by the access network once the MUD file is re-fetched, but might not be desirable to the network or its administrator, and noticing the change would require additional logic. In some cases, it might be that the local network administrator, or even the device owner, would like to modify the MUD file of a device to better fit the intended use case of the device, which is currently not catered for by MUD. Also, if the MUD server 13 would disappear (temporarily or permanently), the access network would not have access to any MUD file to apply.

This is resolved in an embodiment by enrolling a MUD device in a network.

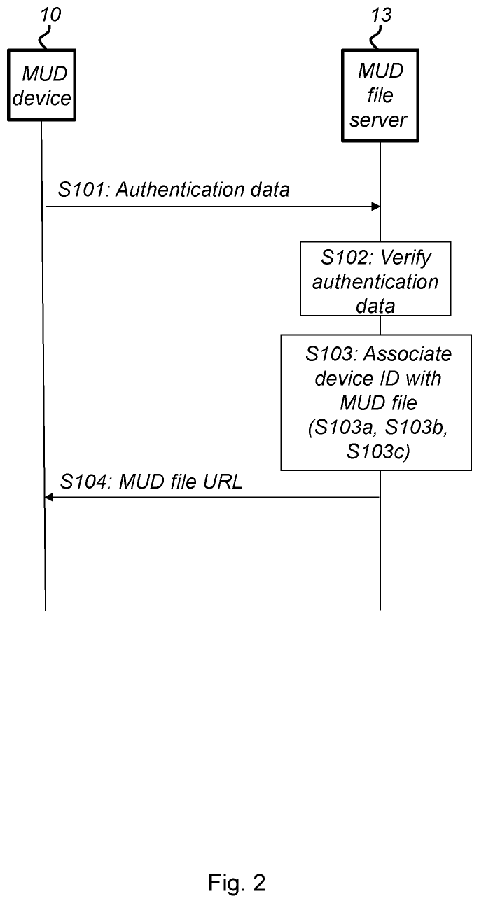

FIG. 2 shows a signaling diagram illustrating a method of enrolling a MUD device at a MUD file server according to this embodiment.

In a first step S101, the MUD device 10 enrolls with the MUD file server 13 in step S101 by providing authentication data to the MUD file server 13. Thus, in step S101, the MUD file server 13 receives authentication data from the MUD device 10

As is understood, to enroll the MUD device 10, a device owner may trigger the MUD 10 device to enroll. This could e.g. be performed via a device management service where the device owner triggers the MUD device 10 to connect to an enrolment interface of the MUD file server 13 via an online facility (potentially hosted by a manufacturer of the MUD device), or if the MUD device 10 is equipped with a user interface, the enrolment could be triggered directly from the MUD device 10. For instance, a MUD device such as a smart light bulb may not be equipped with a user interface, while for instance an IoT temperature sensor indeed may. It may also be envisaged that any authentication between the MUD device 10 and the MUD file server 13 is performed via a trusted third party, which is a common setup for shared secret-based identity approaches. The trusted third party could use some identity federation protocol such as OpenID or create a cryptographic token with which it asserts the identity of the MUD device.

Now, the authentication data may be provided in step S101 in numerous ways. For instance, in case an asymmetric key based approach is utilized, the MUD device 10 may use a private key to provide a digital signature to the MUD file server 13 in step S101, which uses a corresponding public key of the asymmetric key pair to verify the digital signature in step S102.

In another example, in case a symmetric key based approach is utilized, the MUD device 10 may use a symmetric key to encrypt a piece of data and send the encrypted data to the MUD file server 13 in step S101, which uses the same symmetric key to decrypt the encrypted data and thus verify the received authentication data in step S102.

In yet an example, a message authentication code (MAC) is sent from the MUD device 10 to the MUD file server 13 in step S101 as a means of authentication.

Either way, only a device with access to either the private key (using the asymmetric approach) or the shared symmetric key (using the symmetric approach) may provide the authentication data to the MUD server 13 in step S101, both being secret keys. Thus, in order for the MUD file server 13 to successfully verify the authenticated data of the MUD device 10, the MUD device 10 is required to present knowledge of a secret shared with the MUD file server 13, or alternatively a trusted third party.

In this exemplifying embodiment, the MUD file server 13 is assumed to handle a single type of device, such as smart light bulbs, or MUD devices having the same pre-defined communication policy and thus may already have created a MUD file specifying the communication policy for this particular type of device.

The MUD file server 13 will, upon successful verification in step S102, associate an identifier of the MUD device 10 in step S103 with the MUD file assigned to the MUD device 10 and provide the MUD device 10 with a destination address to the MUD file—in this case a URL—in step S104.

As will be discussed in the following, there are various approaches of associating the MUD file assigned to the MUD device 10 with an identifier of the MUD device 10, for instance:
S103a: the identifier is included in the MUD file,
   either the identifier is included in an individual MUD file assigned to the MUD device, or
   for each enrolled MUD device, a MUD device identifier is added to a common MUD file shared by a plurality of MUD devices,
S103b: the identifier is included in the URL, for instance as plain text, as a hashed version, as part of the file name, etc, or
S103c: the identifier is included in both the MUD file and the URL.

Advantageously, the identifier is associated with the MUD file to allow the MUD manager 12 to subsequently verify that a device presenting the URL indeed is an enrolled device, and not a malicious device performing e.g. an attack using a stolen URL.

The MUD device 10 has thus advantageously been enrolled with the MUD file server 13, in which the MUD device 10 is provided with a pointer in the form of a URL to a MUD file specifying the MUD device communication policy in response to successful verification of authentication data of the MUD device 10. As is understood, in case the identifier is included in an individual MUD file assigned to the MUD device, the pointer is device-specific, whereas if the MUD device identifier is added to a common MUD file shared by a plurality of MUD devices, the pointer is not device-specific.

As is understood, the MUD file manager 13 may acquire the identifier of the MUD device 10 in various ways; for instance, the MUD device 10 may present an identifier as payload data, for example an identifier signed with the public key for providing authentication data in step S101 or alternatively an identifier being encrypted with the symmetric key for providing authentication data in step S101. The enrolling MUD device 10 is thus required to present knowledge of a secret shared with the MUD file server 13 (in order to avoid enrolment of a non-valid device) or a trusted third party, for example in the form of an encrypted challenge in response to the challenge or an encrypted piece of data which can be mapped to a MUD device identifier to which the MUD file server 13 has access (possibly via a trusted third party). There are numerous known methods for proving knowledge of shared secrets, where the authenticator, i.e. the MUD file server 13, challenges the MUD device 10 to provide the knowledge. For instance, for asymmetric keys the identifier may be the public key related to the private key used for generating the signature, whereas for symmetric key based solutions, both parties need to know the shared secret and identifier associated with it in advance. Alternatively, some identity federation scheme could be used via a trusted third party using identity federation (e.g. OpenID). As is understood, any appropriate secure authentication method could be used for proving ownership of the presented identifier.

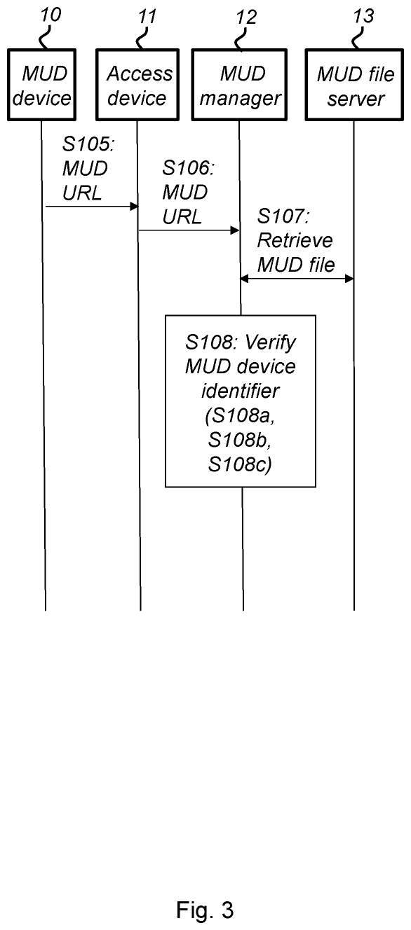

FIG. 3 shows a signaling diagram illustrating the MUD device 10 connecting to an access network according to an embodiment via router 11 as previously discussed with reference to the prior art MUD architecture illustrated in FIG. 1.

Thus, the MUD device 10 connects to the access network via the access device 11 in S105 and provides the MUD URL that was previously received from the MUD file server 13 in S104 to the access device 11, which in its turn forwards the MUD URL to the MUD manager 12 in step S106. Upon connecting to the access network, the MUD device 10 needs to authenticate itself (using any appropriate known authentication method) towards the access device 11 by e.g. presenting its identity and a shared secret in the form of a password or pin code. Alternatively, the authentication may be performed via a trusted third party, for instance in the form of an authentication server of the access network. The MUD manager 12 will thus acquire this authenticated identifier of the MUD device 10 in step S106, either from the access device 11 or the authentication server.

The MUD manager 13 retrieves the MUD file from the MUD file server 13 in step S107 as indicated by the destination address in the MUD URL and verifies the MUD device identifier in S108 against the authenticated identifier acquired in step S106. Alternatively, the MUD manager 12 acquires the authenticated identifier after it has fetched the MUD file in step S107.

Now, depending on the approach that was selected by the MUD file server 13 in step S103, this may be performed as:
S108a: verify that the authenticated identifier of the MUD device 10 attained by the MUD manager 12 corresponds to that in the MUD file (if the identifier previously was added to the MUD file as proposed in S103a), or
S108b: verify that the authenticated identifier of the MUD device 10 attained by the MUD manager 12 corresponds to that in the MUD URL (if the identifier previously was added to the MUD file as proposed in S103b), or
S108c: verify that the authenticated identifier of the MUD device 10 attained by the MUD manager 12 corresponds both to that in the MUD file and that in the MUD URL (if the identifier previously was added to the MUD file and the MUD URL as proposed in S103c).

Advantageously, by checking that there is a match between the authenticated identifier of the MUD device 10 attained by the MUD manager 12 and the identifier of either the MUD file, the MUD URL or both, the MUD manager 12 is capable of verifying that the MUD device 10 indeed has been successfully enrolled with the MUD file server 13 (as described with reference to FIG. 2).

Thus, the proposed approach greatly hampers a malicious device from creating a fake MUD file and/or MUD URL or modifying an existing MUD file and associated communication policies and thereafter attempting to obtain more favourable policies by preventing a manipulated MUD URL.

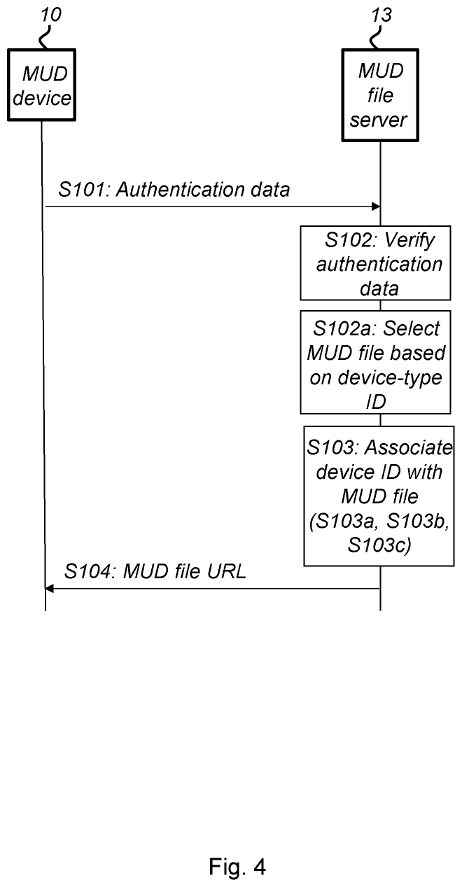

FIG. 4 shows a signaling diagram illustrating a further embodiment, where the MUD file server 13 hosts MUD files for many different MUD device types, which MUD files thus specify different preconfigured communication policies.

Steps S101 and S102 are typically identical to those already described with reference to FIG. 2.

However, since the MUD file server 13 hosts many different types of MUD files, the server 13 requires information as to which type of device the MUD device 10 belongs in order to associate a MUD file with the MUD device 10 that has a correct predefined communication policy.

For instance, the MUD file server 13 may handle MUD files of many different types of devices, such as e.g. the above-mentioned smart light bulbs and IoT temperature sensors, and further security systems, connected household appliances, etc., each type of device being assigned a certain type of MUD file specifying the appropriate communication policy.

In this example, the MUD file server 13 will after having verified the authentication data of the MUD device 10 in step S102 acquire a device-type identifier of the MUD device 10 in step S102a.

In an example embodiment, the authentication data in step S101 is configured to comprise the device-type identifier of the MUD device 10. For instance, the MUD device 10 may use its private key to provide a digital signature to the device-type identifier and send the signed device-type identifier to the MUD file server 13 in step S101 as authentication data, or use its symmetric key shared with the MUD file server 13 to encrypt the device-type identifier and send the encrypted device-type identifier to the MUD file server 13 in step S101 as authentication data.

Either way, only a device with access to either the private key (using the asymmetric approach) or the shared symmetric key (using the symmetric approach) may provide the authentication data to the MUD server 13 in step S101, both being secret keys.

Alternatively, the MUD file server 13 could interact with a manufacturer of the authenticated MUD device 10 and request information about device type for this particular identified MUD device 10. Other alternatives for determining device type includes remote attestation of the MUD device (thereby learning e.g. device state and type), and fetching device information from the MUD device which requires that the MUD device stores e.g. device type information in a memory that cannot be modified, i.e. read-only, so that the information cannot be changed to prevent spoofing.

The MUD file server 13 will upon successful verification in step S102 determine in step S102a from the acquired device-type identifier which specific MUD file to associate with the MUD device 10 and then perform the association in step S103, as previously described with reference to FIG. 2. For instance, assuming that the MUD device 10 is a smart light bulb, then a certain MUD file may be selected while if the MUD device 10 is an IoT temperature sensor, another MUD file is selected.

As previously described, the MUD URL is provided to the MUD device 10 in step S104, and verification may subsequently be undertaken as described hereinabove throughout steps S105-S108.

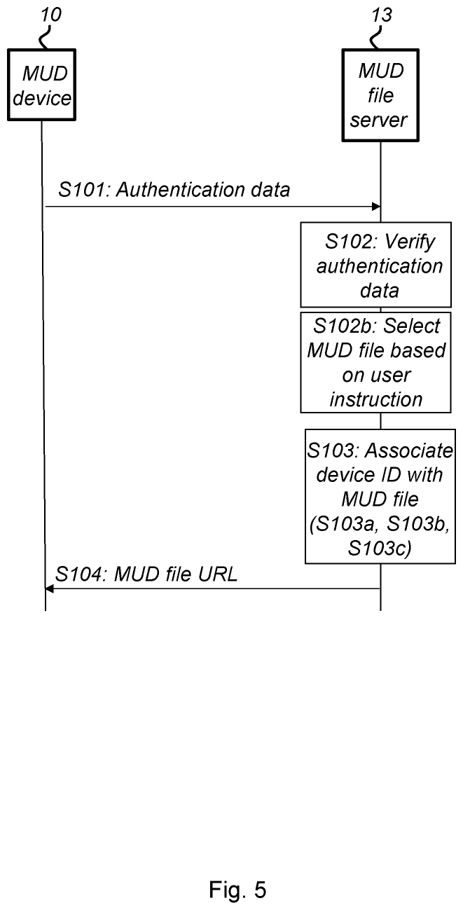

FIG. 5 shows a signaling diagram illustrating another embodiment, where the MUD file server 13 again hosts MUD files for many different MUD device types, which MUD files thus specify different preconfigured communication policies.

Steps S101 and S102 are typically identical to those already described with reference to FIG. 2.

However, in this particular embodiment, the user of the MUD device 10 is allowed to specify a MUD file to be assigned (i.e. specifying a particular communication policy).

In this example, the MUD file server 13 will after having verified the authentication data of the MUD device 10 in step S102 allow the user of the MUD device 10 to specify the MUD file to be assigned in step S102b before the MUD file server 13 performs the association in step S103. Thus, the MUD file server selects a MUD file to be assigned to the MUD device 10 based on a user instruction of an owner of the MUD device 10.

As previously described, the MUD URL is provided to the MUD device 10 in step S104, and verification may subsequently be undertaken as described hereinabove throughout steps S105-S108.

Advantageously, the user can tailor the communication policies and restrictions of his/her MUD devices on a per device level. As previously mentioned, this may occur via an interface provided by a manufacturer of the MUD device 10.

In case tailoring is allowed in step s102b, the MUD file associated with the MUD device 10 in step S103 is device-specific, and not shared with other devices of the same type, since the tailored MUD file typically would specify a different communication policy than other MUD files for the same type of MUD device.

As is understood, while only one MUD device identifier is authenticated and associated with a MUD file in FIGS. 2, 4 and 5, it is envisaged that the MUD file server 13 e.g. to increase a security level verifies numerous sets of authentication data in step S102, each being associated with a specific identifier of the MUD device 10. All these identifiers would subsequently be associated with the MUD file in step S103 and the MUD manager 12 may subsequently verify each MUD device identifier in step S108 against the MUD file and/or MUL URL, similar to what has been described with reference to FIG. 3 if the purpose is to increase the security level.

The MUD file server 13 could generate multiple new destination indicators in the form of MUD URLs, one for each authenticated identity, and all URLs could point to the same MUD file. This is further advantageous in a scenario where the MUD device 10 connects to different access networks, in that different identifiers may be used to access different access networks, while only one enrolment procedure is required (even if further enrolments subsequently may be undertaken). By adding numerous identifiers to the MUD file, the MUD device 10 is provided with multiple access credentials for different access network. Further. manufacturer-issued credentials could be enrolled in the MUD file—

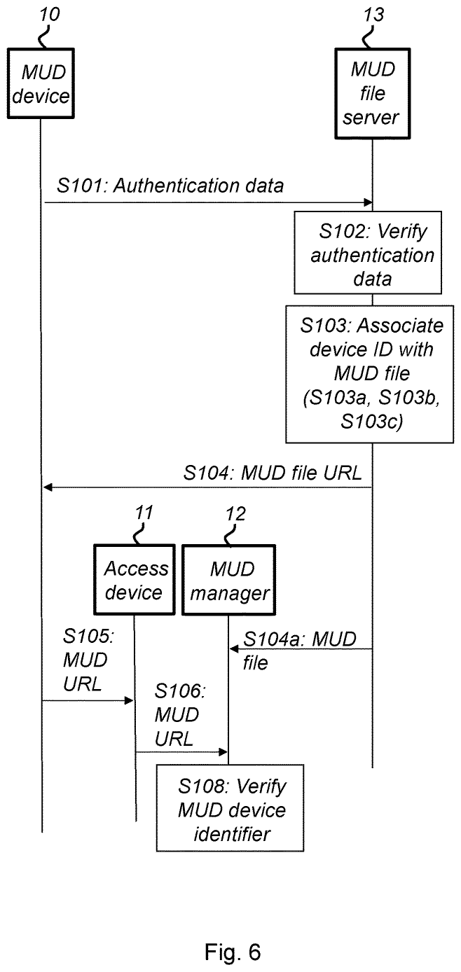

FIG. 6 shows a signaling diagram illustrating another embodiment, wherein steps S101-S104 are identical to those already described with reference to FIG. 4.

However, in this particular embodiment, the MUD file is further distributed to the MUD manager 12 in step S104a, after the MUD device 10 has been enrolled. It may further be envisaged that the MUD URL is distributed to the MUD manager 12. Alternatively, the MUD file is provided to the MUD manager 12 by the MUD device 10 via the access device 11 in step S106 at a first access request of the MUD device 10.

Thus, upon the MUD device 10 subsequently attaching to the access network and providing the MUD URL to the access device 11 in step S105, which access device 11 further forwards the MUD URL to the MUD manager 12 in step S106, the MUD manager 12 does not have to turn to the MUD file server 13 for retrieving the MUD file, since it was received either from the MUD file server 13 in step S104a or from the access device 11 in step S106.

Rather, the MUD manager 13 accesses the MUD file it retrieved in step S104a and verifies the MUD device identifier in S108, for instance by verifying that an identifier of the MUD device 10 attained by the MUD manager 12 in S106 corresponds to the identifier in the locally stored MUD file.

By storing a local copy of the MUD file and utilizing the locally stored MUD file instead of fetching the file from the MUD file server 13, the MUD file is usable even if the MUD file server 13 is offline.

Optionally, the MUD manager 12 can verify that it still has the latest version of the MUD file by querying the MUD file server 13 about e.g., a hash of the MUD file indicating when the file has been edited.

Throughout the embodiments described hereinabove, the MUD manager 12 may record that a specific MUD device 10 has been verified in step S108 and has a device specific MUD file. As a consequence, the MUD manager 12 may determine that the specific MUD device 10 only will be allowed to use device specific MUD files. This means that the MUD device 10 would not be allowed network access if the device provides a MUD URL that is not bound to the already verified identity of the device. This effectively prevents rollback to previous generic MUD URLs of MUD files shared with other devices as well as usage of a MUD URL not actually matching the device (e.g., using the MUD file of a MUD device with more privileges).

Further throughout the embodiments described hereinabove, to increase the level of security, the MUD file server 13 may when associating a MUD device identifier with a MUD file in step S103 further digitally sign the MUD file using a private key such that the MUD manager 12 subsequently can verify the digital signature using the corresponding public key, either in step S104a or in step S108.

If the MUD device identifier is added to the MUD file and the MUD file thereafter is signed by the MUD file server 13, a receiver such as e.g. the MUD manager 12 can verify that the MUD file server 13 indeed has added the device identifier to the MUD file. Otherwise, there is a risk that an attacker modifies the MUD file and provides a MUD file comprising a non-valid MUD device identifier. This risk is mitigated by alternatively communicating the MUD file from the MUD server 13 to the MUD manager 12 over a secure and trusted channel.

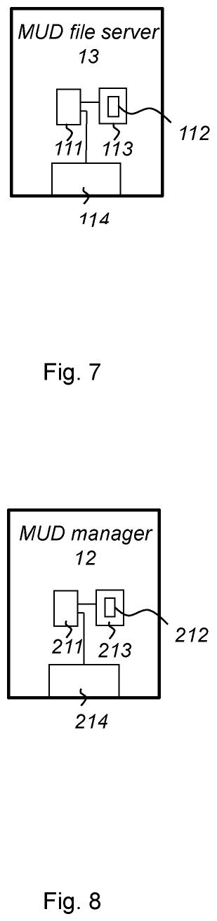

FIG. 7 illustrates a MUD file server 13 configured to enroll a MUD device 10 according to an embodiment, where the steps of the method performed by the MUD file server 13 in practice are performed by a processing unit 111 embodied in the form of one or more microprocessors arranged to execute a computer program 112 downloaded to a storage medium 113 associated with the microprocessor, such as a Random Access Memory (RAM), a Flash memory or a hard disk drive. The processing unit 111 is arranged to cause the MUD file server 13 to carry out the method according to embodiments when the appropriate computer program 112 comprising computer-executable instructions is downloaded to the storage medium 113 and executed by the processing unit 111. The storage medium 113 may also be a computer program product comprising the computer program 112. Alternatively, the computer program 112 may be transferred to the storage medium 113 by means of a suitable computer program product, such as a Digital Versatile Disc (DVD) or a memory stick. As a further alternative, the computer program 112 may be downloaded to the storage medium 113 over a network. The processing unit 111 may alternatively be embodied in the form of a digital signal processor (DSP), an application specific integrated circuit (ASIC), a field-programmable gate array (FPGA), a complex programmable logic device (CPLD), etc. The MUD file server 13 further comprises a communication interface 114 (wired and/or wireless) over which the MUD file server 13 is configured to transmit and receive data.

FIG. 8 illustrates a MUD manager 12 configured to verify a MUD device according to an embodiment, where the steps of the method performed by the MUD manager 12 in practice are performed by a processing unit 211 embodied in the form of one or more microprocessors arranged to execute a computer program 212 downloaded to a storage medium 213 associated with the microprocessor, such as a RAM, a Flash memory or a hard disk drive. The processing unit 211 is arranged to cause the MUD manager 12 to carry out the method according to embodiments when the appropriate computer program 212 comprising computer-executable instructions is downloaded to the storage medium 213 and executed by the processing unit 211. The storage medium 213 may also be a computer program product comprising the computer program 212. Alternatively, the computer program 212 may be transferred to the storage medium 213 by means of a suitable computer program product, such as a DVD or a memory stick. As a further alternative, the computer program 212 may be downloaded to the storage medium 213 over a network. The processing unit 211 may alternatively be embodied in the form of a DSP, an ASIC, an FPGA, a CPLD, etc. The MUD manager 12 further comprises a communication interface 214 (wired and/or wireless) over which the MUD manager 12 is configured to transmit and receive data.

An example of a MUD device may be an IoT device for use in one or more application domains, these domains comprising, but not limited to, home, city, wearable technology, extended reality, industrial application, and healthcare.

By way of example, the IoT device for a home (or an office, a building or an infrastructure) may be a baking scale, a coffee machine, a grill, a fridge, a refrigerator, a freezer, a microwave oven, an oven, a toaster, a water tap, a water heater, a water geyser, a sauna, a vacuum cleaner, a washer, a dryer, a dishwasher, a door, a window, a curtain, a blind, a furniture, a light bulb, a fan, an air-conditioner, a cooler, an air purifier, a humidifier, a speaker, a television, a laptop, a personal computer, a gaming console, a remote control, a vent, an iron, a steamer, a pressure cooker, a stove, an electric stove, a hair dryer, a hair styler, a mirror, a printer, a scanner, a photocopier, a projector, a hologram projector, a 3D printer, a drill, a hand-dryer, an alarm clock, a clock, a security camera, a smoke alarm, a fire alarm, a connected doorbell, an electronic door lock, a lawnmower, a thermostat, a plug, an irrigation control device, a flood sensor, a moisture sensor, a motion detector, a weather station, an electricity meter, a water meter, and a gas meter.

By further ways of example, the IoT device for use in a city, e.g., urban, or rural areas, may be connected street lighting, a connected traffic light, a traffic camera, a connected road sign, an air control/monitor, a noise level detector, a transport congestion monitoring device, a transport controlling device, an automated toll payment device, a parking payment device, a sensor for monitoring parking usage, a traffic management device, a digital kiosk, a bin, an air quality monitoring sensor, a bridge condition monitoring sensor, a fire hydrant, a manhole sensor, a tarmac sensor, a water fountain sensor, a connected closed circuit television, a scooter, a hoverboard, a ticketing machine, a ticket barrier, a metro rail, a metro station device, a passenger information panel, an onboard camera, and other connected device on a public transport vehicle.

As further way of example, the IoT device may be a wearable device, or a device related to extended reality, wherein the device related to extended reality may be a device related to augmented reality, virtual reality, merged reality, or mixed reality. Examples of such IoT devices may be a smart-band, a tracker, a haptic glove, a haptic suit, a smartwatch, clothes, eyeglasses, a head mounted display, an ear pod, an activity monitor, a fitness monitor, a heart rate monitor, a ring, a key tracker, a blood glucose meter, and a pressure meter.

As further ways of example, the IoT device may be an industrial application device wherein an industrial application device may be an industrial unmanned aerial vehicle, an intelligent industrial robot, a vehicle assembly robot, and an automated guided vehicle.

As further ways of example, the IoT device may be a transportation vehicle, wherein a transportation vehicle may be a bicycle, a motor bike, a scooter, a moped, an auto rickshaw, a rail transport, a train, a tram, a bus, a car, a truck, an airplane, a boat, a ship, a ski board, a snowboard, a snow mobile, a hoverboard, a skateboard, roller-skates, a vehicle for freight transportation, a drone, a robot, a stratospheric aircraft, an aircraft, a helicopter and a hovercraft.

As further ways of example, the IoT device may be a health or fitness device, wherein a health or fitness device may be a surgical robot, an implantable medical device, a non-invasive medical device, and a stationary medical device which may be: an in-vitro diagnostic device, a radiology device, a diagnostic imaging device, and an x-ray device.

The aspects of the present disclosure have mainly been described above with reference to a few embodiments and examples thereof. However, as is readily appreciated by a person skilled in the art, other embodiments than the ones disclosed above are equally possible within the scope of the invention, as defined by the appended patent claims.

Thus, while various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1-50. (canceled)

51. A method of a Manufacturer Usage Description (MUD) file server enrolling a MUD device, comprising:
receiving authentication data from the MUD device;
verifying the received authentication data;
associating an identifier of the MUD device with a MUD file assigned to the MUD device; and
providing the MUD device with a destination to the assigned MUD file.

52. The method of claim 51, wherein the verifying of the received authentication data comprises the MUD device proving knowledge of a secret shared with the MUD file server or a trusted third party.

53. The method of claim 51, wherein the associating of an identifier of the MUD device with a MUD file assigned to the MUD device comprises:
including the identifier of the MUD device in the MUD file.

54. The method of claim 53, wherein the identifier of the MUD device is included in a MUD file specifically assigned to the MUD device.

55. The method of claim 53, wherein the identifier of the MUD device is added to a common MUD file shared with a plurality of MUD devices.

56. The method of claim 51, wherein the associating of an identifier of the MUD device with a MUD file assigned to the MUD device comprises:
including the identifier of the MUD device with the destination.

57. The method of claim 51, the provided destination being a uniform resource locator(URL).

58. The method of claim 51, the identifier of the MUD device being acquired via payload data received with the authentication data or via communication header data received with the authentication data.

59. The method of claim 51, further comprising:
selecting a MUD file to be assigned to the MUD device based on a device-type identifier of the MUD device.

60. The method of claim 51, further comprising:
selecting a MUD file to be assigned to the MUD device based on a user instruction of an owner of the MUD device.

61. The method of claim 51, further comprising:
receiving a request from a MUD manager to provide the MUD file of the MUD device in response to which the MUD file is distributed to the MUD manager.

62. The method of claim 51, further comprising:
distributing the MUD file and/or the destination to a MUD manager.

63. The method of claim 51, further comprising:
providing the MUD file with a digital signature to be verified with a public key corresponding to a private key utilized to provide the digital signature.

64. The method of claim 51, wherein the verifying of the received authentication data comprises verifying received authentication data for a plurality of identifiers for the MUD device and the associating an identifier of the MUD device with a MUD file assigned to the MUD device comprises associating the plurality of identifiers with the MUD file.

65. The method of claim 64, wherein the providing the MUD device with a destination to the assigned MUD file comprises providing a separate destination indicator for each identifier, all destination indicators indicating the same MUD file.

66. A computer program product comprising a computer readable medium, the computer readable medium having the computer program comprising computer-executable instructions for causing a MUD file server to perform the steps recited in claim 1 when the computer-executable instructions are executed on a processing unit included in the MUD file server.

67. A Manufacturer Usage Description (MUD) file server configured to enroll a MUD device, the MUD file server comprising a processing unit and a memory, said memory containing instructions executable by said processing unit, whereby the MUD file server is operative to:
receive authentication data from the MUD device;
verify the received authentication data;
associate an identifier of the MUD device with a MUD file assigned to the MUD device; and
provide the MUD device with a destination to the assigned MUD file.

68. The MUD file server of claim 67, wherein the verifying of the received authentication data comprises the MUD device proving knowledge of a secret shared with the MUD file server or a trusted third party.

69. The MUD file server of claim 67, further being operative to, when associating an identifier of the MUD device with a MUD file assigned to the MUD device:
include the identifier of the MUD device in the MUD file.

70. The MUD file server of claim 69, wherein the identifier of the MUD device is configured to be included in a MUD file specifically assigned to the MUD device.
